(19) United States
(12) Patent Application Publication
(10) Pub. No.: US 2023/0065367 A1
(43) Pub. Date: Mar. 2, 2023

(54) GLASS RUN

(71) Applicant: TOYODA GOSEI CO., LTD., Kiyosu-shi (JP)

(72) Inventors: Masatoshi Nojiri, Kiyosu-shi (JP); Yasuhiro Shimizu, Kiyosu-shi (JP)

(21) Appl. No.: 17/866,957

(22) Filed: Jul. 18, 2022

(30) Foreign Application Priority Data
Aug. 31, 2021 (JP) 2021-140940

(51) Int. Cl. B60J 10/76; B60J 5/04; B60J 10/21

(52) U.S. Cl. CPC B60J 10/76; B60J 5/0402; B60J 10/21

(57) ABSTRACT

In a glass run including a bottom wall, a vehicle exterior side wall, and a vehicle interior side wall as a basic skeleton and attached to a groove portion formed in a door frame, a seal lip protruding portion protruding to the vehicle interior side wall side is formed at or in a vicinity of a seal lip distal end portion of a general surface on the vehicle interior side wall side of a vehicle interior seal lip, a side wall protruding portion protruding to a vehicle exterior side is formed on a vehicle exterior surface of the vehicle interior side wall between the vehicle interior seal lip and the bottom wall, a sub lip protruding obliquely from the side wall protruding portion in a vehicle interior surface direction of the vehicle interior seal lip is formed, and the seal lip protruding portion and the sub lip abut on each other.

### CROSS REFERENCE TO RELATED APPLICATION

This application claims the priority benefit of Japanese Patent Application No. 2021-140940 filed on Aug. 31, 2021. The entirely of the above-mentioned patent application is hereby incorporated by reference herein and made a part of this application.

### BACKGROUND OF THE INVENTION

### (1) Field of the Invention

The present invention relates to a glass run attached to a door frame formed on a door of a vehicle such as an automobile.

### (2) Description of Related Art

In a door of a vehicle, a door frame is provided in an upper portion of a door main body, a glass run having a channel shape is fitted and locked in a door frame groove portion formed in an inner peripheral edge of the door frame, raising and lowering of the door glass is guided by a glass seal portion on the vehicle interior and exterior sides of the vehicle of the glass run, and an inside and an outside of a vehicle compartment are sealed.

In the glass run described above, a bottom wall, a vehicle exterior side wall positioned on the vehicle exterior side, and a vehicle interior side wall positioned on the vehicle interior side are configured as a basic skeleton (main body portion). Further, the glass run includes a vehicle exterior seal lip and a vehicle interior seal lip extending from distal ends of both side wall portions or the vicinity thereof toward the inside of the main body portion. Further, the main body portion of the glass run is attached to the door frame groove portion (attachment portion) provided along the inner periphery of the door frame, and the glass run is sealed by both the seal lips so that the peripheral edge portions of the inner and outer surfaces of the door glass which is raised and lowered are sandwiched. In addition, the glass run also plays a role of supporting the peripheral edge portions of the door glass, guiding the raising and lowering of the door glass, and suppressing rattling of the door glass.

Meanwhile, in a state where the door glass is positioned slightly below a fully closed position, the door glass is easily displaced in the vehicle interior direction. In this state, in a case where the door glass vibrates in vehicle interior and exterior directions, which is caused when, for example, the automobile travels on a rough road, the door glass and the seal lips may be instantaneously separated from each other. In a case where the door glass and the seal lips are brought into contact with each other again from this separated state, and the separation and the contact are repeated, there is a risk that an abnormal noise (hitting noise) caused by the contact may occur. In particular, when the seal lips deteriorate over time and the elastic force decreases, the seal lips are easily separated from the door glass when the door glass vibrates, and the problem of generation of abnormal noise becomes more remarkable.

As a technique for solving the above problem, for example, a technique described in JP 2018-149984 A is known. A structure of a glass run in JP 2018-149984 A will be described with reference to FIGS. 1 and 12. FIG. 1 is a front view of a left front door 100 of an automobile as viewed from a vehicle exterior side. A door frame 320 is formed on an upper portion of a door main body 210 constituting the front door 100. The door frame 320 and the upper end edge of the door main body 210 form a window opening. A glass run 110 is attached to the inner peripheral edge of the window opening and the inside of the door main body 210 to guide a raising and lowering operation of a door glass 600.

FIG. 12 illustrates a vertical cross section (cross section taken along the line Y-Y in FIG. 1) of a vertical frame portion of the door frame 320. The glass run 110 in this portion is usually molded by an extrusion molding method. The glass run 110 is formed in a channel shape (U-shaped cross section) with a bottom wall 200, a vehicle exterior side wall 300, and a vehicle interior side wall 400 as a basic skeleton. A vehicle exterior seal lip 310 that is in contact with a front surface (vehicle exterior side) of the door glass 600 is formed on the vehicle exterior side wall 300, and a vehicle interior seal lip 410 that is in contact with a back surface (vehicle interior side) of the door glass 600 is formed at a distal end of the vehicle interior side wall 400. In addition, between the vehicle interior seal lip 410 and the bottom wall 200, a sub lip 430 protruding in a direction opposite to the vehicle interior seal lip 410 is formed toward the vehicle exterior side.

The vehicle interior seal lip 410 includes a protruding portion 440 on the back surface thereof, so that a protruding surface 450 is provided at a position protruding from a general surface of the back surface. When the door glass 600 is displaced from a reference position to the vehicle interior side, the state can be changed to a first support state in which the distal end portion of the sub lip 430 extending from the vehicle interior side wall 400 and the protruding surface 450 abut on and slide on each other, and a second support state in which the distal end portion of the sub lip 430 is detached from the protruding surface 450 and a portion of the sub lip 430 on the root side with respect the distal end portion abuts on the protruding portion 440.

As a result, since the protruding portion 440 is provided on the rear surface side of the vehicle interior seal lip 410, the vehicle interior seal lip 410 at the portion is thickened, and the sub lip 430 that extends from the vehicle interior side wall 400 and can abut on the protruding surface 450 of the protruding portion 440 is provided, the force with which the vehicle interior seal lip 410 comes into pressure contact with the door glass 600 is increased, and even when the door glass 600 vibrates, it is possible to prevent a situation in which the vehicle interior seal lip 410 is instantaneously separated from the door glass 600, and for example, it is possible to prevent a situation in which an abnormal noise (hitting noise) caused by contact occurs when the vehicle interior seal lip 410 and the door glass 600 are brought into a contact state from a separated state.

Note that, in JP 2018-149984 A, the force with which the vehicle interior seal lip 410 comes into pressure contact with the door glass 600 in the first support state and the second support state, that is, a reaction force of the vehicle interior seal lip 410 against the door glass 600 is described as “As the door glass is largely displaced from the reference position to the vehicle interior side, the door glass and the vehicle interior seal lip strongly come into pressure contact with each other, and the reaction force of the vehicle interior seal lip increases. However, when the state changes from the first support state to the second support state, the support of the distal end portion of the sub lip on the protruding surface is canceled, so that the increase in the reaction force of the vehicle interior seal lip is temporarily suppressed.” (paragraph 0014), indicating that the first support state is larger than the second support state.

### SUMMARY OF THE INVENTION

In the technique of JP 2018-149984 A, the protruding portion 440 having the protruding surface 450 is formed on the back surface of the vehicle interior seal lip 410 in the extrusion-molded portion as described above. Usually, the cross-sectional shape of the extrusion-molded portion of the glass run does not change. Therefore, in JP 2018-149984 A, the protruding portion 440 is formed on the entire vertical side portion, and the protruding portion 440 and the sub lip 430 may abut on each other at the time of sliding contact with the door glass 600. Therefore, a reaction force from the vehicle interior seal lip 410 with respect to the door glass 600 increases, and as a result, there still remains a problem that the slidability deteriorates. In addition, since the protruding portion 440 is formed on the entire vertical side portion, the weight of the glass run increases.

Therefore, the present invention provides a glass run in which a structure that does not adversely affect the slidability of a door glass, suppresses an increase in weight as much as possible, and increases a reaction force with respect to the door glass is formed in a die-molded portion connecting the extrusion-molded members, and generation of abnormal noise in a state where the door glass is positioned slightly below a fully closed position can be prevented including a case of deterioration over time.

In order to solve the above problems, the present invention of claim 1 is a glass run attached to a door frame groove portion formed in a door frame, the glass run including a bottom wall, a vehicle exterior side wall, and a vehicle interior side wall as a basic skeleton, a vehicle exterior seal lip formed at or in a vicinity of a distal end of the vehicle exterior side wall, and a vehicle interior seal lip formed at or in a vicinity of a distal end of the vehicle interior side wall, in which, in a die-molded portion at the time of die molding for connecting extrusion-molded members or a region continuous with the die-molded portion at the time of die molding and the extrusion-molded members connected to the die-molded portion, regarding at least a vertical side portion corresponding to one of vertical edge portions in front and rear of a vehicle of the door glass, a seal lip protruding portion protruding to the vehicle interior side wall side is formed at or in a vicinity of a seal lip distal end portion of a general surface on the vehicle interior side wall side of the vehicle interior seal lip, a sub lip is formed on a vehicle exterior surface of the vehicle interior side wall between the vehicle interior seal lip and the bottom wall, the sub lip protruding obliquely in a vehicle interior surface direction of the vehicle interior seal lip, and the seal lip protruding portion and the sub lip abut on each other at the time of sliding contact with the door glass.

When the door glass is positioned slightly below the fully closed position and the door glass vibrates in vehicle interior and exterior directions, the door glass and the vehicle interior seal lip are repeatedly separated from and brought into contact with each other, and a region where abnormal noise (hitting noise) caused by the contact is generated is often observed in the die-molded portion at the time of die molding for connecting the extrusion-molded members, or the die-molded portion and the vicinity thereof. In the present invention of claim 1, in the region continuous with the die-molded portion at the time of die molding and the extrusion-molded members connected to the die-molded portion, the vehicle interior seal lip is formed with the seal lip protruding portion protruding to the vehicle interior side wall side from the seal lip distal end portion of the general surface on the vehicle interior side wall side or a vicinity thereof, and the seal lip protruding portion and the sub lip abut on each other. Therefore, when the door glass is displaced to the vehicle interior side, the vehicle interior seal lip strongly presses the sub lip against the vehicle interior side wall side. As a result, it is possible to prevent the vehicle interior seal lip from being separated from the door glass by the reaction force (pressing force) from the sub lip to the rear surface side of the vehicle interior seal lip, and to prevent generation of the abnormal noise.

In addition, since the seal lip protruding portion is formed in the die-molded portion at the time of die molding or the region continuous with the die-molded portion at the time of die molding and the extrusion-molded members connected to the die-molded portion, it is possible to suppress an increase in weight of the entire glass run as compared with a case where the seal lip protruding portion is formed in the entire region of the extrusion-molded portion.

Furthermore, since the structure is formed in the die-molded portion at the time of die molding or the region continuous with the die-molded portion at the time of die molding and the extrusion-molded members connected to the die-molded portion, the slidability in the extrusion-molded portion is not affected.

In addition, it is not necessary to consider and discuss the influence on other functions of the extrusion-molded member due to the formation of the seal lip protruding portion and the sub lip in the extrusion-molded member during the extrusion molding, and the development time can be shortened.

In addition, the “region continuous with the die-molded portion at the time of die molding and the extrusion-molded members connected to the die-molded portion” means a region in which a cross-sectional shape of die molding is reflected not only on the die-molded portion but also on the extrusion-molded portion connected to the die-molded portion at the time of molding since a molding die often covers the die-molded portion and the extrusion-molded portion in the case of connecting the extrusion-molded members in die molding.

The present invention of claim 2 is a glass run in which, in the invention of claim 1, a side wall protruding portion protruding to a vehicle exterior side is formed on the vehicle exterior surface of the vehicle interior side wall between the vehicle interior seal lip and the bottom wall, and the sub lip is formed to obliquely protrude from the side wall protruding portion in the vehicle interior surface direction of the vehicle interior seal lip.

Deterioration over time occurs not only in the vehicle interior seal lip but also in the sub lip. Therefore, there is a concern about a problem that the reaction force (pressing force) to the rear surface side of the vehicle interior seal lip due to deterioration of the sub lip is reduced, so that the vehicle interior seal lip is separated from the door glass, and abnormal noise occurs again.

In the present invention of claim 2, the side wall protruding portion protruding to the vehicle exterior side is formed on the vehicle exterior surface of the vehicle interior side wall between the vehicle interior seal lip and the bottom wall, and the sub lip is formed to obliquely protrude from the side wall protruding portion in the vehicle interior surface direction of the vehicle interior seal lip. Therefore, the length of the sub lip can be shortened, and even when the sub lip deteriorates over time, it is possible to suppress a decrease in reaction force (pressing force) to the rear surface side of the vehicle interior seal lip, and it is possible to prevent the vehicle interior seal lip from being separated from the door glass and to prevent generation of abnormal noise again.

In addition, since the side wall protruding portion is formed on the vehicle exterior surface of the vehicle interior side wall between the vehicle interior seal lip and the bottom wall, an increase in weight of the entire glass run can be suppressed as much as possible as compared with a case where the entire vehicle interior side wall is formed thick.

Furthermore, since the structure is formed in the die-molded portion at the time of die molding for connecting the extrusion-molded members or the region continuous with the die-molded portion at the time of die molding and the extrusion-molded members connected to the die-molded portion, the slidability in the extrusion-molded portion is not affected. In addition, it is not necessary to consider and discuss the influence on other functions of the extrusion-molded member due to the formation of the seal lip protruding portion, the side wall protruding portion, and the sub lip in the extrusion-molded member during the extrusion molding, and the development time can be shortened.

The present invention of claim 3 is a glass run in which, in the invention of claim 1, a protruding surface is formed on the seal lip protruding portion, and a protruding surface protruding portion protruding to the vehicle interior side wall side is formed on the seal lip distal end portion side of the vehicle interior seal lip of the protruding surface, and, when the door glass is displaced to a vehicle interior side, the vehicle interior seal lip and the sub lip are configured to be changeable between a first support state in which a sub lip distal end portion of the sub lip and the protruding surface of the vehicle interior seal lip protruding portion excluding the protruding surface protruding portion abut on each other, and a second support state in which a vehicle exterior surface of the sub lip and the protruding surface protruding portion abut on each other.

In the present invention of claim 3, the protruding surface is formed on the seal lip protruding portion, and the protruding surface protruding portion protruding to the vehicle interior side wall side is formed on the seal lip distal end portion side of the vehicle interior seal lip of the protruding surface, and, when the door glass is displaced to the vehicle interior side, the first support state in which the sub lip distal end portion and the protruding surface of the vehicle interior seal lip protruding portion excluding the protruding surface protruding portion abut on each other is established, so that the protruding surface presses the sub lip to the vehicle interior side. As a result, it is possible to prevent the vehicle interior seal lip from being separated from the door glass by the reaction force (pressing force) from the sub lip to the rear surface side of the vehicle interior seal lip via the seal lip protruding portion, and generation of the abnormal noise.

In addition, when the door glass is further displaced to the vehicle interior side, the second support state in which the vehicle exterior surface of the sub lip and the protruding surface protruding portion abut on each other is established, so that the force pressing the sub lip to the vehicle interior side is stronger than in the first support state. As a result, it is possible to prevent the vehicle interior seal lip from being separated from the door glass by the reaction force (pressing force) from the sub lip to the rear surface side of the vehicle interior seal lip, and to prevent generation of the abnormal noise.

The present invention of claim 4 is a glass run in which, in the invention of claim 1, a protruding surface having a coupling surface with the general surface of the vehicle interior seal lip is formed on the seal lip protruding portion, and, when the door glass is displaced to a vehicle interior side, the vehicle interior seal lip and the sub lip are configured to be changeable between a first support state in which a sub lip distal end portion of the sub lip or a vehicle exterior surface of the sub lip and a corner portion of the coupling surface and the protruding surface abut on each other, and a second support state in which the vehicle exterior surface of the sub lip and the protruding surface abut on each other.

In the present invention of claim 4, the protruding surface having the coupling surface with the general surface of the vehicle interior seal lip is formed on the seal lip protruding portion, and, when the door glass is displaced to the vehicle interior side, the vehicle interior seal lip and the sub lip are in the first support state in which the sub lip distal end portion of the sub lip or the vehicle exterior surface of the sub lip and the corner portion of the coupling surface and the protruding surface abut on each other, so that the corner portion of the coupling surface and the protruding surface presses the sub lip to the vehicle interior side. As a result, it is possible to prevent the vehicle interior seal lip from being separated from the door glass by the reaction force (pressing force) from the sub lip to the rear surface side of the vehicle interior seal lip via the seal lip protruding portion, and generation of the abnormal noise.

In addition, when the door glass is further displaced to the vehicle interior side, the second support state in which the vehicle exterior surface of the sub lip and the protruding surface abut on each other is established, so that the force pressing the sub lip to the vehicle interior side wall side is stronger than in the first support state. As a result, it is possible to prevent the vehicle interior seal lip from being separated from the door glass by the reaction force (pressing force) from the sub lip to the rear surface side of the vehicle interior seal lip, and to prevent generation of the abnormal noise.

The present invention of claim 5 is a glass run in which, in the invention of claim 1, when the door glass is displaced to a vehicle interior side, the vehicle interior seal lip and the sub lip are configured to be changeable between a first support state in which a sub lip distal end portion of the sub lip and a general surface of the vehicle interior seal lip abut on each other, and a second support state in which the sub lip distal end portion and the general surface of the vehicle interior seal lip abut on each other and a vehicle exterior surface of the sub lip and the seal lip protruding portion abut on each other.

In the present invention of claim 5, when the door glass is displaced to the vehicle interior side, the vehicle interior seal lip and the sub lip are in the first support state in which the sub lip distal end portion of the sub lip and the general surface of the vehicle interior seal lip abut on each other, so that the general surface of the vehicle interior seal lip presses the sub lip to the vehicle interior side. As a result, it is possible to prevent the vehicle interior seal lip from being separated from the door glass by the reaction force (pressing force) from the sub lip to the rear surface side of the vehicle interior seal lip, and generation of the abnormal noise.

In addition, when the door glass is further displaced to the vehicle interior side, the second support state in which the sub lip distal end portion and the general surface of the vehicle interior seal lip abut on each other, and the vehicle exterior surface of the sub lip and the seal lip protruding portion abut on each other is established, so that the force pressing the sub lip to the vehicle interior side wall side is stronger than in the first support state. As a result, it is possible to prevent the vehicle interior seal lip from being separated from the door glass by the reaction force (pressing force) from the sub lip to the rear surface side of the vehicle interior seal lip, and to prevent generation of the abnormal noise.

The present invention of claim 6 is a glass run attached to a door frame groove portion formed in a door frame, the glass run including a bottom wall, a vehicle exterior side wall, and a vehicle interior side wall as a basic skeleton, a vehicle exterior seal lip formed at or in a vicinity of a distal end of the vehicle exterior side wall, and a vehicle interior seal lip formed at or in a vicinity of a distal end of the vehicle interior side wall, in which, in a die-molded portion at the time of die molding for connecting extrusion-molded members or a region continuous with the die-molded portion at the time of die molding and the extrusion-molded members connected to the die-molded portion, regarding at least a vertical side portion corresponding to one of vertical edge portions in front and rear of a vehicle of the door glass, a seal lip protruding portion protruding to the vehicle interior side wall side is formed at or in a vicinity of a seal lip distal end portion of a general surface on the vehicle interior side wall side of the vehicle interior seal lip, a side wall protruding portion protruding to a vehicle exterior side is formed on a vehicle exterior surface of the vehicle interior side wall between the vehicle interior seal lip and the bottom wall, and the seal lip protruding portion and the side wall protruding portion abut on each other at the time of sliding contact with the door glass.

In the present invention of claim 6, the seal lip protruding portion protruding to the vehicle interior side wall side is formed at or in a vicinity of the distal end portion of the general surface on the vehicle interior side wall side of the vehicle interior seal lip, the side wall protruding portion protruding to the vehicle exterior side is formed on the vehicle exterior surface of the vehicle interior side wall between the vehicle interior seal lip and the bottom wall, and the seal lip protruding portion and the side wall protruding portion abut on each other at the time of sliding contact with the door glass. Therefore, particularly when the door glass is thick, the seal lip protruding portion and the side wall protruding portion abut on each other at the time of sliding contact with the door glass without forming a sub lip, so that, when the door glass is displaced to the vehicle interior side, the seal lip is strongly pressed to the door glass. As a result, it is possible to prevent the vehicle interior seal lip from being separated from the door glass by the increased reaction force (pressing force) of the vehicle interior seal lip with respect to the door glass, and to prevent generation of abnormal noise.

In addition, since the structure is formed in the die-molded portion at the time of die molding for connecting the extrusion-molded members or the region continuous with the die-molded portion at the time of die molding and the extrusion-molded members connected to the die-molded portion, the slidability in the extrusion-molded portion is not affected.

In addition, since the seal lip protruding portion and the side wall protruding portion are formed in the die-molded portion at the time of die molding or the region continuous with the die-molded portion at the time of die molding and the extrusion-molded members connected to the die-molded portion, it is possible to suppress an increase in weight of the entire glass run as compared with a case where the seal lip protruding portion and the side wall protruding portion are formed in the entire region of the extrusion-molded portion.

In addition, it is not necessary to consider and discuss the influence on other functions of the extrusion-molded member due to the formation of the seal lip protruding portion and the side wall protruding portion in the extrusion-molded member during the extrusion molding, and the development time can be shortened.

In the region continuous with the die-molded portion at the time of die molding and the extrusion-molded members connected to the die-molded portion, the vehicle interior seal lip is formed with the seal lip protruding portion protruding to the vehicle interior side wall side from the seal lip distal end portion of the general surface on the vehicle interior side wall side or a vicinity thereof, and the seal lip protruding portion and the sub lip abut on each other. Therefore, when the door glass is displaced to the vehicle interior side, the sub lip is strongly pressed against the vehicle interior side wall side. As a result, it is possible to prevent the vehicle interior seal lip from being separated from the door glass by the reaction force (pressing force) from the sub lip to the rear surface side of the vehicle interior seal lip, and to prevent generation of the abnormal noise.

In addition, since the seal lip protruding portion is formed in the die-molded portion at the time of die molding or the region continuous with the die-molded portion at the time of die molding and the extrusion-molded members connected to the die-molded portion, it is possible to suppress an increase in weight of the entire glass run as compared with a case where the seal lip protruding portion is formed in the entire region of the extrusion-molded portion.

Furthermore, since the structure is formed in the die-molded portion at the time of die molding or the region continuous with the die-molded portion at the time of die molding and the extrusion-molded members connected to the die-molded portion, the slidability in the extrusion-molded portion is not affected.

In addition, it is not necessary to consider and discuss the influence on other functions of the extrusion-molded member due to the formation of the seal lip protruding portion and the sub lip in the extrusion-molded member during the extrusion molding, and the development time can be shortened.

### BRIEF DESCRIPTION OF THE DRAWINGS

FIG. 1 is a front view of an automobile door as viewed from the vehicle exterior side;

FIG. 2A is a front view illustrating a glass run used for a door frame of FIG. 1, and FIG. 2B is an enlarged view of an X portion of FIG. 2A;

FIG. 3 is a cross-sectional view for explaining a relationship among a door glass, a vehicle interior seal lip, and a sub lip when the door glass is displaced to a vehicle interior side in the glass run of a first embodiment of the present invention, and is a cross-sectional view corresponding to the line A-A of FIG. 2B;

FIG. 4 is a cross-sectional view illustrating a relationship between displacement of the door glass and deformation of the vehicle interior seal lip and the sub lip in a glass run of a second embodiment of the present invention in a first support state, and is a cross-sectional view corresponding to the line A-A of FIG. 2B;

FIG. 5 is a cross-sectional view illustrating a relationship between displacement of the door glass and deformation of the vehicle interior seal lip and the sub lip in the glass run of the second embodiment of the present invention in a second support state, and is a cross-sectional view corresponding to the line A-A of FIG. 2B;

FIG. 6 is a graph showing a relationship between displacement of the door glass and a load on the vehicle interior side of the door glass in the glass run of the second embodiment of the present invention;

FIG. 7 is a cross-sectional view illustrating a relationship between displacement of the door glass and deformation of the vehicle interior seal lip and the sub lip in a glass run of a third embodiment of the present invention in the first support state, and is a cross-sectional view corresponding to the line A-A of FIG. 2B;

FIG. 8 is a cross-sectional view illustrating a relationship between displacement of the door glass and deformation of the vehicle interior seal lip and the sub lip in the glass run of the third embodiment of the present invention in the second support state, and is a cross-sectional view corresponding to the line A-A of FIG. 2B;

FIG. 9 is a cross-sectional view illustrating a relationship between displacement of the door glass and deformation of the vehicle interior seal lip and the sub lip in a glass run of a fourth embodiment of the present invention in the first support state, and is a cross-sectional view corresponding to the line A-A of FIG. 2B;

FIG. 10 is a cross-sectional view illustrating a relationship between displacement of the door glass and deformation of the vehicle interior seal lip and the sub lip in the glass run of the fourth embodiment of the present invention in the second support state, and is a cross-sectional view corresponding to the line A-A of FIG. 2B;

FIG. 11 is a cross-sectional view for explaining a relationship among the door glass, the vehicle interior seal lip, and a side wall protruding portion when the door glass is displaced to the vehicle interior side in a glass run of a fifth embodiment of the present invention, and is a cross-sectional view corresponding to the line A-A of FIG. 2B; and

FIG. 12 is a cross-sectional view illustrating a related-art attachment structure for a glass run, and is a cross-sectional view corresponding to the line Y-Y in FIG. 1 (JP 2018-149984 A).

### DETAILED DESCRIPTION OF PREFERRED EMBODIMENTS

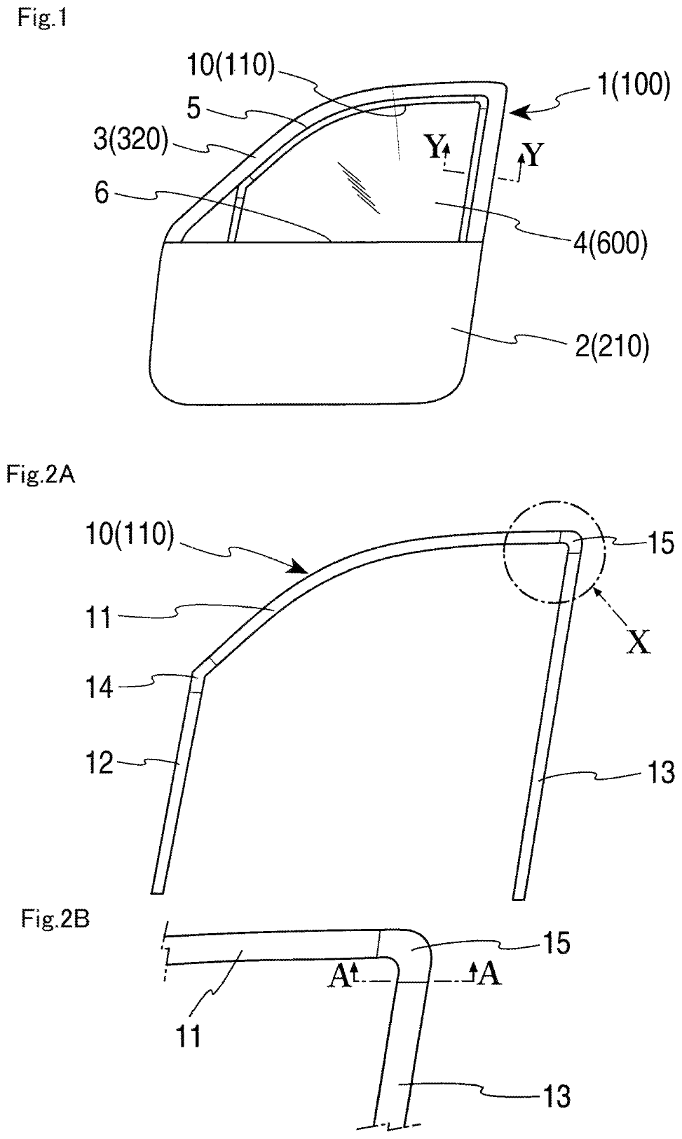

A first embodiment of the present invention will be described with reference to FIGS. 1 to 3. FIG. 1 is a front view of a left front door 1 of an automobile as viewed from a vehicle exterior side. A door frame 3 is attached to an upper portion of a door main body 2 constituting the front door 1. The door frame 3 and the upper end edge of the door main body 2 form a window opening. A glass run 10 is attached to the inner peripheral edge of the window opening and the inside of the door main body 2 to guide a raising and lowering operation of the door glass 4. The present invention is applicable not only to the left front door 1 but also to a right front door and left and right rear doors. In addition, the present invention is also applicable to a sliding door of the door glass which is raised and lowered.

FIG. 2A is a simplified front view of only the glass run 10 of FIG. 1 as viewed from the vehicle exterior side. The glass run 10 includes a first extrusion-molded portion 11 corresponding to a lateral frame portion of the door frame 3, a second extrusion-molded portion 12 (front vertical side portion) corresponding to a front vertical frame portion of the front door 1, and a third extrusion-molded portion 13 (rear vertical side portion) corresponding to a rear vertical frame portion. The front end portion of the first extrusion-molded portion 11 is connected to the upper end portion of the second extrusion-molded portion 12 by a first die-molded portion 14. In addition, the rear end portion of the first extrusion-molded portion 11 is connected to the upper end portion of the third extrusion-molded portion 13 by a second die-molded portion 15.

Here, a case where the door glass 4 vibrates in vehicle interior and exterior directions, which is caused when, for example, the automobile travels on a rough road in a state where the door glass 4 is positioned slightly below a fully closed position between the door glass 4 and the glass run 10 will be described. When the door glass 4 is raised to the uppermost position and is completely closed, the door glass 4 abuts on the first extrusion-molded portion 11 of the glass run 10, the second extrusion-molded portion 12 corresponding to the front vertical frame portion of the front door 1, and the third extrusion-molded portion 13 corresponding to the rear vertical frame portion of the front door 1 and is supported from three directions. Therefore, the door glass 4 does not vibrate in the vehicle interior and exterior directions even when, for example, the automobile travels on a rough road.

When the door glass 4 is slightly lowered and the abutment between the door glass 4 and the first extrusion-molded portion 11 is released, the door glass 4 is supported in two vertical directions mainly by abutting on the first die-molded portion 14 and the second extrusion-molded portion 12 of the glass run 10 corresponding to the front vertical frame portion of the front door 1 and the second die-molded portion 15 and the third extrusion-molded portion 13 corresponding to the rear vertical frame portion. At this time, for example, when the automobile travels on a rough road, the door glass 4 vibrates in the vehicle interior and exterior directions, and the problem of the abnormal noise may occur.

When the door glass 4 is further lowered, in the relationship between the door glass 4 and the glass run 10, the door glass 4 is still supported in the two directions by abutting on the second extrusion-molded portion 12 corresponding to the front vertical frame portion of the front door 1 and the third extrusion-molded portion 13 corresponding to the rear vertical frame portion, but the door glass 4 is supported in substantially three directions by being attached to a belt line 6 (FIG. 1) of the front door 1, for example, by being supported by a belt line weatherstrip. Therefore, at this stage, for example, even when the automobile travels on a rough road, the vibration of the door glass 4 in the vehicle interior and exterior directions is extremely reduced.

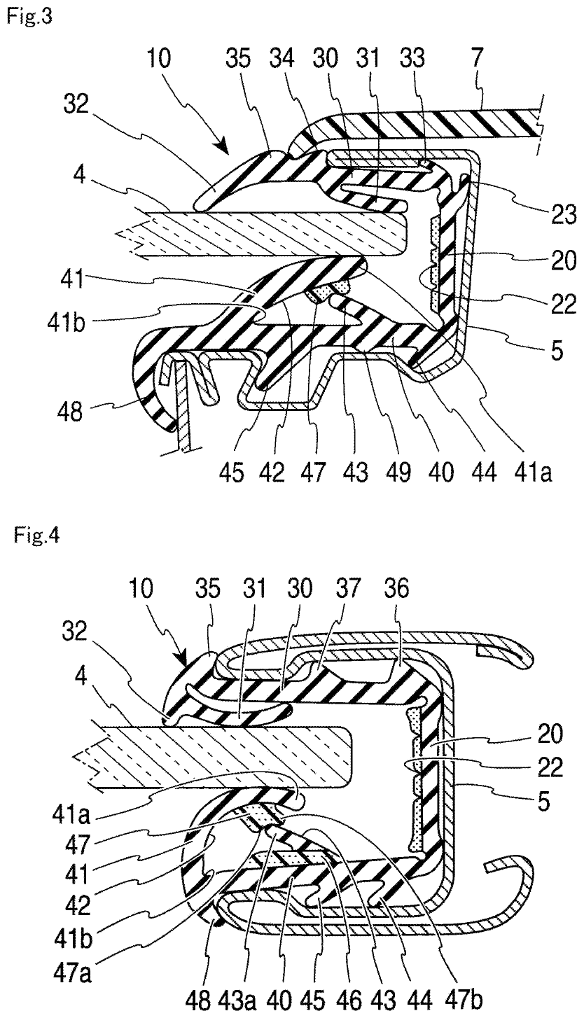

FIG. 3 is a cross-sectional view corresponding to the line A-A in FIG. 2B, and is a view in the vicinity of a coupling portion with the third extrusion-molded portion 13 corresponding to the rear vertical frame portion in the second die-molded portion 15. The glass run 10 includes a bottom wall 20, a vehicle exterior side wall 30, and a vehicle interior side wall 40 as a basic skeleton, and is formed in a channel shape (substantially U-shaped cross section).

The bottom wall 20 is formed in a substantially plate shape, and a plurality of bottom wall recesses 22 are formed on an inner surface (abutment side with the door glass 4) of the bottom wall 20 continuously in parallel in the longitudinal direction. An abutment lip 23 formed on a door frame groove portion 5 side abuts on the door frame groove portion 5.

On the vehicle exterior side of the vehicle exterior side wall 30, a first vehicle exterior holding lip 33 and a second vehicle exterior holding lip 34 that are locked to the door frame groove portion 5 are formed in the vicinity of a coupling portion with the bottom wall 20 and in the distal end portion direction of the vehicle exterior side wall 30, and the door frame groove portion 5 formed in a bent manner is held by the first vehicle exterior holding lip 33 and the second vehicle exterior holding lip 34.

On the vehicle interior side of the vehicle exterior side wall 30, a vehicle exterior seal lip 31 that is in contact with the door glass 4 is formed toward the bottom wall 20 side, and on a distal end portion of the vehicle exterior side wall 30, a vehicle exterior cover lip 32 is formed toward the side opposite to the vehicle exterior seal lip 31. The vehicle exterior cover lip 32 abuts on the vehicle exterior surface of the door glass 4 together with the vehicle exterior seal lip 31, so that rainwater, dust, and noise can be prevented from entering, and sealing performance can be improved.

In addition, a locking portion 35 is formed at the root portion of the vehicle exterior cover lip 32 toward the vehicle exterior side to fix an end portion of a pillar garnish 7 and seal the gap between the pillar garnish 7 and the surface of the door glass 4.

On the other hand, a vehicle interior seal lip 41 is formed on the vehicle exterior side of the vehicle interior side wall 40. The vehicle interior seal lip 41 extends from between the distal end portion of the vehicle interior side wall 40 and the bottom wall 20 to the vehicle exterior side and the bottom wall 20 side, and has a side surface on the vehicle exterior side in sliding contact with the door glass 4. In addition, a seal lip protruding portion 47 protruding from a general surface 42 on the vehicle interior side wall 40 side of the vehicle interior seal lip 41 is formed slightly on a root portion 41b side of the vehicle interior seal lip 41 from a seal lip distal end portion 41a of the vehicle interior seal lip 41.

In addition, between the vehicle interior seal lip 41 and the bottom wall 20 in the vehicle interior side wall 40, a sub lip 43 protruding in a direction opposite to the vehicle interior seal lip 41 is formed toward the vehicle exterior side. The sub lip 43 has a substantially uniform wall thickness, and has a distal end portion formed in an arc shape. Note that the sub lip 43 may not the uniform wall thickness and may have a shape which is thicker on the vehicle interior side wall 40 side and thinner toward the distal end.

In addition, on the vehicle interior side of the vehicle interior side wall 40, a vehicle interior first holding lip 44 locked with an arc-shaped curved portion of the door frame groove portion 5 having the curved portion and a vehicle interior second holding lip 45 are formed in the vicinity of a coupling portion with the bottom wall 20, and an abutment lip 49 is formed between the holding lips 44 and 45. The vehicle interior side wall 40 is held in the curved door frame groove portion 5 by the holding lips 44 and 45 and the abutment lip 49.

In addition, a vehicle interior cover lip 48 is formed on the opposite side (vehicle interior side) of the vehicle interior seal lip 41 at the distal end of the vehicle interior side wall 40. The vehicle interior cover lip 48 abuts on the distal end of the door frame groove portion 5 to prevent entry of rainwater, dust, and noise, thereby being capable of improving sealing performance.

Note that, in FIG. 3, the seal lip protruding portion 47 is drawn with a different display from the vehicle interior seal lip 41 and the sub lip 43, but this is for emphasizing the presence of the above-described member, and does not mean that the seal lip protruding portion 47 is formed of, for example, a different material. Therefore, the seal lip protruding portion 47 may be formed of the same material as the vehicle interior seal lip 41, may be formed to, for example, have different hardness even in the case of the same material, and of course, may be formed of different substances.

FIG. 3 illustrates an abutment state between the vehicle interior seal lip 41 and the sub lip 43 when the door glass 4 is slightly lowered and displaced to the vehicle interior side. As is apparent from FIG. 3, the seal lip protruding portion 47 abuts on the sub lip 43 in a manner of pressing the sub lip 43 to the vehicle interior side.

As a result, a reaction force is generated in the sub lip 43 on vehicle exterior side, and the reaction force presses the vehicle interior surface of the door glass 4 to the vehicle exterior side via the vehicle interior seal lip 41 including the seal lip protruding portion 47. Therefore, it is possible to prevent the reaction force with respect to the door glass 4 from increasing, to prevent the vehicle interior seal lip from being separated from the door glass, and to prevent generation of abnormal noise.

When the door glass 4 is displaced further to the vehicle interior side than in FIG. 3, the sub lip 43 is further bent and deformed to the vehicle interior side, and the reaction force to the vehicle interior seal lip 41 increases.

Next, a second embodiment will be described with reference to FIGS. 4 to 6. As illustrated in FIG. 4, on the vehicle interior side of the vehicle exterior side wall 30, the vehicle exterior seal lip 31 that is in contact with the door glass 4 is formed toward the bottom wall 20 side, and on the distal end portion of the vehicle exterior side wall 30, the vehicle exterior cover lip 32 is formed toward the side opposite to the vehicle exterior seal lip 31.

In addition, on the vehicle exterior side of the vehicle exterior side wall 30, a vehicle exterior first holding rib 36 and a vehicle exterior second holding rib 37 locked to the door frame groove portion 5 having an arc-shaped curved portion are formed. Further, the locking portion 35 is formed toward the vehicle exterior side at the root portion of the vehicle exterior seal lip 31 and the vehicle exterior cover lip 32, and is fixed to an end portion of the door frame groove portion 5.

On the other hand, the vehicle interior seal lip 41 in contact with the door glass 4 is formed at the distal end of the vehicle interior side wall 40 toward the bottom wall 20. In addition, on the vehicle interior side of the vehicle interior side wall 40, the vehicle interior first holding lip 44 locked with an arc-shaped curved portion of the door frame groove portion 5 having the curved portion and the vehicle interior second holding lip 45 are formed in the vicinity of the coupling portion with the bottom wall 20.

The seal lip protruding portion 47 protruding from the general surface 42 on the vehicle interior side wall 40 side of the vehicle interior seal lip 41 is formed slightly on the root portion 41b side of the vehicle interior seal lip 41 from the seal lip distal end portion 41a of the vehicle interior seal lip 41. In the seal lip protruding portion 47, a protruding surface 47a is formed on the vehicle interior side wall 40 side, and an arc-shaped protruding surface protruding portion 47b protruding to the vehicle interior side wall 40 side is formed on the seal lip distal end portion 41a side of the vehicle interior seal lip 41 of the protruding surface 47a. Note that the protruding surface protruding portion 47b is not limited to the arc shape, and may have another shape such as a triangular shape or a trapezoidal shape.

A side wall protruding portion 46 having a substantially trapezoidal shape, which has a short side on the vehicle exterior side and protrudes to the vehicle exterior side, is formed on a vehicle exterior surface of the vehicle interior side wall 40 between the root portion 41b of the vehicle interior seal lip 41 and the bottom wall 20.

In addition, the sub lip 43 is formed to obliquely protrude in the vehicle interior surface direction of the vehicle interior seal lip 41 from the distal end on the bottom wall 20 side of the short side of the side wall protruding portion 46 having the substantially trapezoidal shape. Therefore, the sub lip 43 is formed to have a length shorter than that in the related art. The sub lip 43 has a substantially uniform wall thickness, and has a distal end portion formed in an arc shape. Note that the sub lip 43 may not the uniform wall thickness and may have a shape which is thicker on the vehicle interior side wall 40 side and thinner toward the distal end.

In FIG. 4, the sub lip 43 is formed to obliquely protrude in the vehicle interior surface direction of the vehicle interior seal lip 41 from the distal end on the bottom wall 20 side of the short side of the side wall protruding portion 46 having the substantially trapezoidal shape, and the inclined surface (the right inclined surface in FIG. 4) on the bottom wall 20 side of the side wall protruding portion 46 having the substantially trapezoidal shape is drawn to also serve as the vehicle exterior surface of the related-art sub lip 43. However, the present invention is not limited thereto, and the inclined surface on the bottom wall 20 side of the side wall protruding portion 46 having the substantially trapezoidal shape and the vehicle exterior surface of the sub lip 43 may have different angles, and the sub lip 43 may be formed so as to protrude from other than the distal end on the bottom wall 20 side of the short side of the side wall protruding portion 46 having the substantially trapezoidal shape.

In addition, in FIG. 4 (the same applies to FIG. 4 and subsequent drawings), the seal lip protruding portion 47 and the side wall protruding portion 46 are drawn with different displays from the vehicle interior seal lip 41, the vehicle interior side wall 40, and the sub lip 43, but this is for emphasizing the presence of the above-described members and does not mean that they are formed of, for example, different materials. Therefore, the seal lip protruding portion 47 and the side wall protruding portion 46 may be formed of the same material as the vehicle interior seal lip 41 and the vehicle interior side wall 40, may be formed to, for example, have different hardness even in the case of the same material, and of course, may be formed of different substances.

The vehicle interior cover lip 48 is formed on the opposite side (vehicle interior side) of the vehicle interior seal lip 41 at the distal end of the vehicle interior side wall 40. In the drawing, the vehicle interior cover lip 48 is drawn in a shape continuous from the vehicle interior seal lip 41, but the present invention is not limited thereto.

FIG. 4 illustrates an abutment state between the vehicle interior seal lip 41 and the sub lip 43 in a first support state when the door glass 4 is slightly lowered and displaced to the vehicle interior side. The abutment state between the vehicle interior seal lip 41 and the sub lip 43 in the first support state is not much different from an abutment state between the vehicle interior seal lip 41 and the sub lip 43 when the door glass 4 is completely closed.

As is clear from FIG. 4, in the first support state, a sub lip distal end portion 43a of the sub lip 43 abuts on the protruding surface 47a of the seal lip protruding portion 47 of the vehicle interior seal lip 41, and the sub lip 43 is pressed toward the vehicle interior side wall 40 and deformed. As a result, a reaction force is generated in the sub lip 43, and the reaction force presses the vehicle interior surface of the door glass 4 to the vehicle exterior side via the vehicle interior seal lip 41 including the seal lip protruding portion 47.

As described above, the sub lip 43 is formed to obliquely protrude in the vehicle interior surface direction of the vehicle interior seal lip 41 from the distal end on the bottom wall 20 side of the short side of the side wall protruding portion 46 having the substantially trapezoidal shape, and is formed to have a length shorter than that in the related art. Therefore, even when the sub lip 43 deteriorates over time, it is possible to suppress a decrease in reaction force (pressing force) to the rear surface side of the vehicle interior seal lip 41, and it is possible to prevent the vehicle interior seal lip 41 from being separated from the door glass 4 and to prevent generation of abnormal noise again.

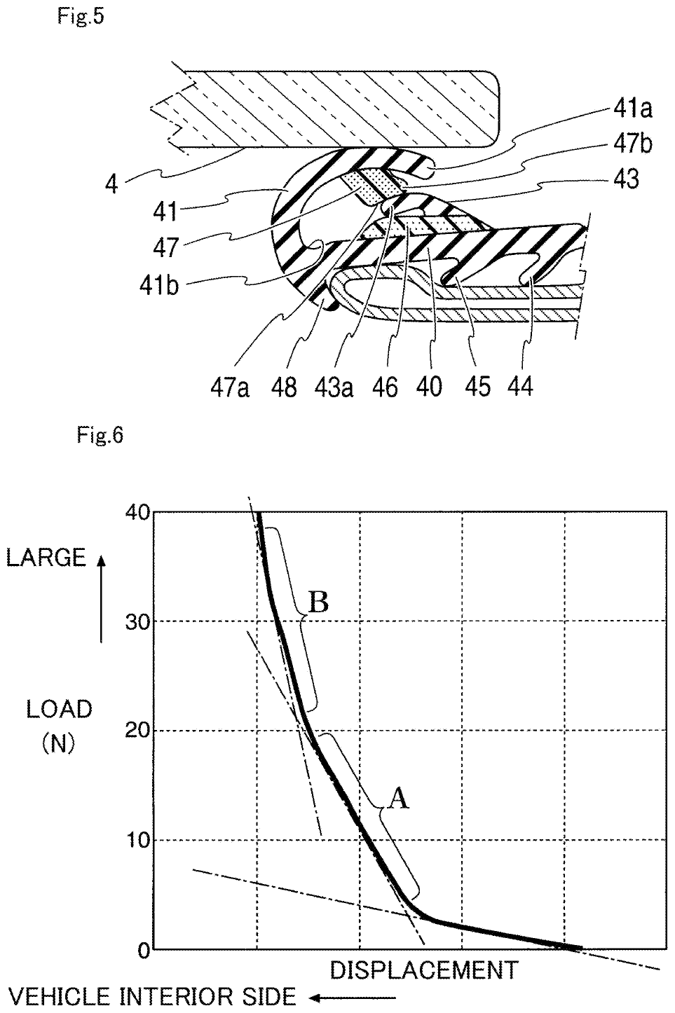

FIG. 5 illustrates an abutment state between the seal lip protruding portion 47 and the sub lip 43 in a second support state when the door glass 4 is further displaced to the vehicle interior side, such as when the door glass 4 is slightly lowered from FIG. 4. As is clear from FIG. 5, when the door glass 4 is further displaced to the vehicle interior side, the vehicle interior seal lip 41 is also deformed to the vehicle interior side following the door glass 4, and the sub lip distal end portion 43a of the sub lip 43 slides on the protruding surface 47a of the seal lip protruding portion 47 to the root portion 41b side of the vehicle interior seal lip 41.

With the deformation of the vehicle interior seal lip 41, the protruding surface protruding portion 47b formed to protrude to the vehicle interior side wall side on the seal lip distal end portion 41a side of the vehicle interior seal lip 41 of the protruding surface 47a is brought into abutment on the vehicle exterior surface of the sub lip 43, and the sub lip 43 is further pressed toward the vehicle interior side wall 40 to be deformed. As a result, the pressing load on the sub lip 43 increases.

FIG. 6 is a graph showing the relationship between the displacement of the door glass 4 and the load on the vehicle interior side of the door glass 4 in the glass run 10. A region in A in FIG. 6 corresponds to the first support state, and a region in B corresponds to the second support state. As is clear from FIG. 6, the reaction force against the door glass 4 is larger in the second support state than in the first support state.

Therefore, the displacement of the door glass 4 to the vehicle interior side by the reaction force of the sub lip 43 and the pressing load of the door glass 4 to the vehicle interior side are generated by the first support state caused by the abutment between the sub lip 43 and the protruding surface 47a of the seal lip protruding portion 47 and the second support state caused by the abutment between the sub lip 43 and the protruding surface protruding portion 47b of the seal lip protruding portion 47. Therefore, even when the door glass 4 vibrates, for example, through traveling on a rough road in a state where the door glass 4 is positioned slightly lower than the fully closed position, that is, in a state where the door glass 4 is displaced to the vehicle interior side, it is possible to prevent the vehicle interior seal lip 41 from separating from the door glass 4 and to prevent generation of abnormal noise.

In addition, the side wall protruding portion 46 having a substantially trapezoidal shape, which has the short side on the vehicle exterior side and protrudes to the vehicle exterior side, is formed on the vehicle exterior surface of the vehicle interior side wall 40 between the root portion 41b of the vehicle interior seal lip 41 and the bottom wall 20, and the sub lip 43 protruding obliquely from the side wall protruding portion 46 in the vehicle interior surface direction of the vehicle interior seal lip 41 is formed. Therefore, even when the sub lip 43 deteriorates over time, it is possible suppress a decrease in reaction force (pressing force) to the rear surface side of the vehicle interior seal lip 41, to prevent the vehicle interior seal lip 41 from being separated from the door glass 4, and to prevent generation of abnormal noise.

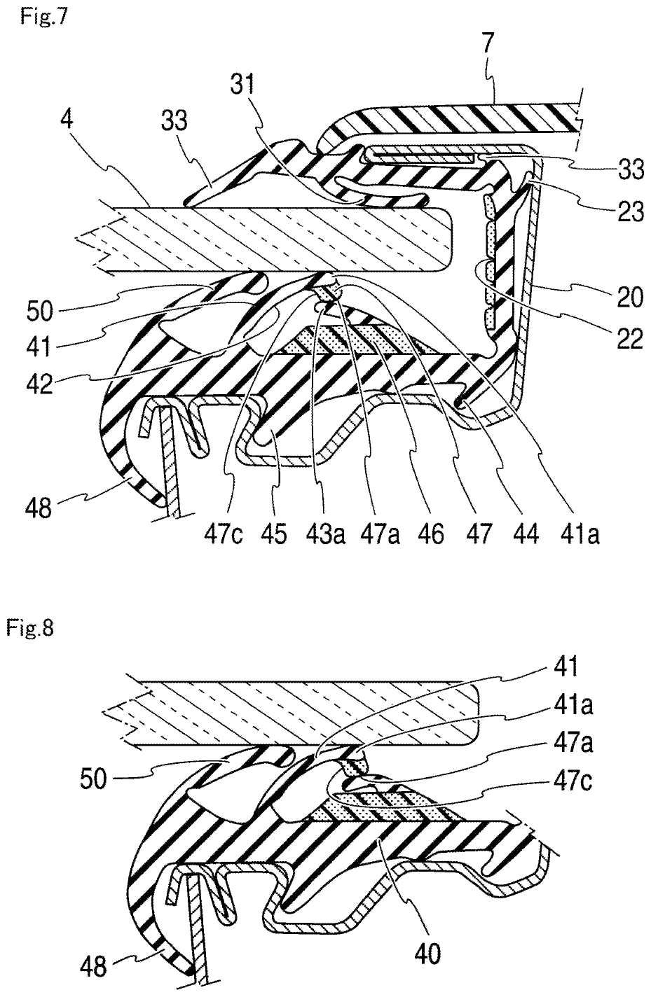

Next, a third embodiment will be described with reference to FIGS. 7 and 8. The third embodiment is different from the first embodiment in that, first, the vehicle exterior side wall 30 side is the same as that of the first embodiment.

Second, on the vehicle interior side wall 40 side, a second vehicle interior seal lip 50 is formed on the distal end side of the vehicle interior seal lip 41 in the same direction as the vehicle interior seal lip 41. The second vehicle interior seal lip 50 and the vehicle interior seal lip 41 double seal the vehicle interior surface of the door glass 4.

Third, the seal lip protruding portion 47 is formed at the seal lip distal end portion 41a of the vehicle interior seal lip 41. Although there is also a difference in that the protruding surface protruding portion 47b is not formed on the protruding surface 47a of the seal lip protruding portion 47, the protruding surface protruding portion 47b may be formed.

Here, since the first and second differences are variations related to the basic skeleton in the glass run 10 and are not directly related to the present invention, the third difference will be described in detail below.

FIG. 7 illustrates an abutment state between the vehicle interior seal lip 41 and the sub lip 43 in the first support state when the door glass 4 is slightly lowered and displaced to the vehicle interior side. The sub lip distal end portion 43a of the sub lip 43 abuts on a corner portion of a coupling surface 47c and the protruding surface 47a of the seal lip protruding portion 47 of the vehicle interior seal lip 41, and the sub lip 43 is pressed toward the vehicle interior side wall 40 and deformed. As a result, a reaction force is generated in the sub lip 43, and the reaction force presses the vehicle interior surface of the door glass 4 to the vehicle exterior side via the vehicle interior seal lip 41 including the seal lip protruding portion 47.

When the door glass 4 is further displaced to the vehicle interior side from FIG. 7, the vehicle interior seal lip 41 is also deformed to the vehicle interior side following the door glass 4, and the sub lip distal end portion 43a of the sub lip 43 slides on the corner portion of the coupling surface 47c and the protruding surface 47a of the seal lip protruding portion 47 to the root portion 41b side of the vehicle interior seal lip 41.

FIG. 8 illustrates an abutment state between the vehicle interior seal lip 41 and the sub lip 43 in the second support state when the door glass 4 is further displaced to the vehicle interior side, for example, slightly lowered from FIG. 7. The vehicle exterior surface of the sub lip 43 abuts on the protruding surface 47a of the seal lip protruding portion 47, and the sub lip 43 is pressed toward the vehicle interior side wall 40 to be further deformed. As a result, the pressing load on the sub lip 43 increases similarly to the case of the second embodiment.

Therefore, the displacement of the door glass 4 to the vehicle interior side by the reaction force of the sub lip 43 and the pressing load of the door glass 4 to the vehicle interior side are generated by the first support state caused by the abutment between the sub lip 43 and the corner portion of the coupling surface 47c and the protruding surface 47a of the seal lip protruding portion 47 and the second support state caused by the abutment between the sub lip 43 and the protruding surface 47a of the seal lip protruding portion 47. Therefore, even when the door glass 4 vibrates, for example, through traveling on a rough road in a state where the door glass 4 is positioned slightly lower than the fully closed position, that is, in a state where the door glass 4 is displaced to the vehicle interior side, it is possible to prevent the vehicle interior seal lip 41 from separating from the door glass 4 and to prevent generation of abnormal noise.

In addition, the side wall protruding portion 46 having a substantially trapezoidal shape, which has the short side on the vehicle exterior side and protrudes to the vehicle exterior side, is formed on the vehicle exterior surface of the vehicle interior side wall 40 between the root portion 41b of the vehicle interior seal lip 41 and the bottom wall 20, and the sub lip 43 protruding obliquely from the side wall protruding portion 46 in the vehicle interior surface direction of the vehicle interior seal lip 41 is formed. Therefore, the length of the sub lip 43 is shorter than that in the related art, and even when the sub lip 43 deteriorates over time, it is possible suppress a decrease in reaction force (pressing force) to the rear surface side of the vehicle interior seal lip 41, to prevent the vehicle interior seal lip 41 from being separated from the door glass 4, and to prevent generation of abnormal noise.

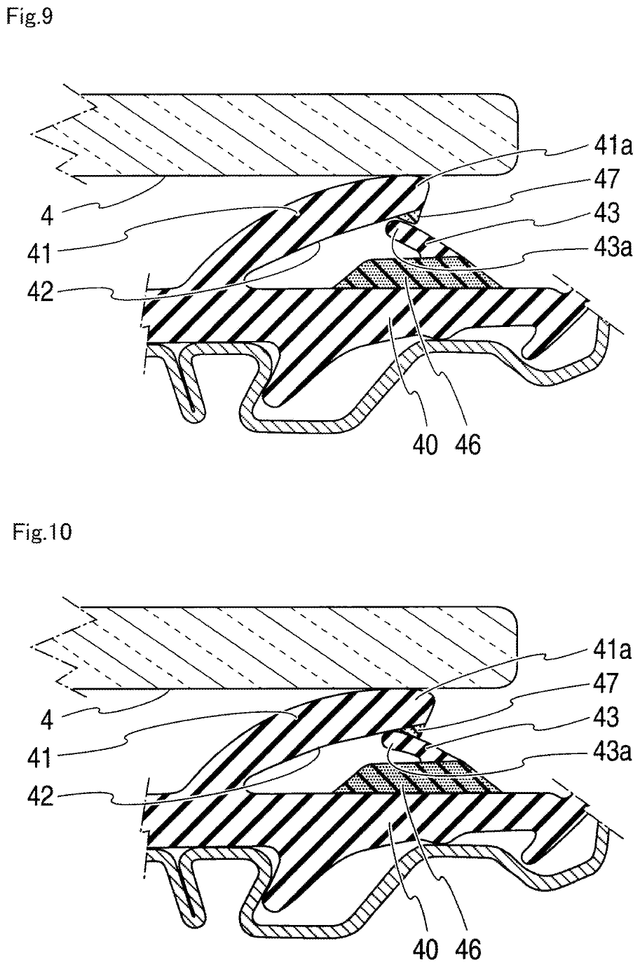

Next, a fourth embodiment will be described with reference to FIGS. 9 and 10. The fourth embodiment is different from the third embodiment in that the seal lip protruding portion 47 does not have the planar protruding surface 47a and has a triangular shape. The seal lip protruding portion 47 may have an arc shape.

FIG. 9 illustrates an abutment state between the vehicle interior seal lip 41 and the sub lip 43 in the first support state when the door glass 4 is slightly lowered and displaced to the vehicle interior side. As is clear from FIG. 9, in the first support state, the sub lip distal end portion 43a of the sub lip 43 abuts on the general surface 42 of the vehicle interior seal lip 41, and the sub lip 43 is pressed toward the vehicle interior side wall 40 and deformed. As a result, a reaction force is generated in the sub lip 43, and the reaction force presses the vehicle interior surface of the door glass 4 to the vehicle exterior side via the vehicle interior seal lip 41.

FIG. 10 illustrates an abutment state between the vehicle interior seal lip 41 and the sub lip 43 in the second support state when the door glass 4 is further displaced to the vehicle interior side, for example, slightly lowered from FIG. 9. When the door glass 4 is further displaced to the vehicle interior side, the vehicle interior seal lip 41 is also deformed to the vehicle interior side following the door glass 4, and the sub lip distal end portion 43a of the sub lip 43 slides on the general surface 42 of the vehicle interior seal lip 41 to the root portion 41b side of the vehicle interior seal lip 41.

In the second support state, the vehicle exterior surface of the sub lip 43 abuts on the seal lip protruding portion 47, and the sub lip 43 is pressed toward the vehicle interior side wall 40 to be further deformed. As a result, the pressing load on the sub lip 43 increases similarly to the case of the second embodiment.

Therefore, the displacement of the door glass 4 to the vehicle interior side by the reaction force of the sub lip 43 and the pressing load of the door glass 4 to the vehicle interior side are generated by the first support state caused by the abutment between the sub lip 43 and the general surface 42 of the vehicle interior seal lip 41 and the second support state caused by the abutment between the sub lip 43 and the general surface 42 and the seal lip protruding portion 47 of the vehicle interior seal lip 41. Therefore, even when the door glass 4 vibrates, for example, through traveling on a rough road in a state where the door glass 4 is positioned slightly lower than the fully closed position, that is, in a state where the door glass 4 is displaced to the vehicle interior side, it is possible to prevent the vehicle interior seal lip 41 from being separated from the door glass 4 and to prevent generation of abnormal noise.

In addition, the side wall protruding portion 46 having a substantially trapezoidal shape, which has the short side on the vehicle exterior side and protrudes to the vehicle exterior side, is formed on the vehicle exterior surface of the vehicle interior side wall 40 between the root portion 41b of the vehicle interior seal lip 41 and the bottom wall 20, and the sub lip 43 protruding obliquely from the side wall protruding portion 46 in the vehicle interior surface direction of the vehicle interior seal lip 41 is formed. Therefore, the length of the sub lip 43 is shorter than that in the related art, and even when the sub lip 43 deteriorates over time, it is possible suppress a decrease in reaction force (pressing force) to the rear surface side of the vehicle interior seal lip 41, to prevent the vehicle interior seal lip 41 from being separated from the door glass 4, and to prevent generation of abnormal noise.

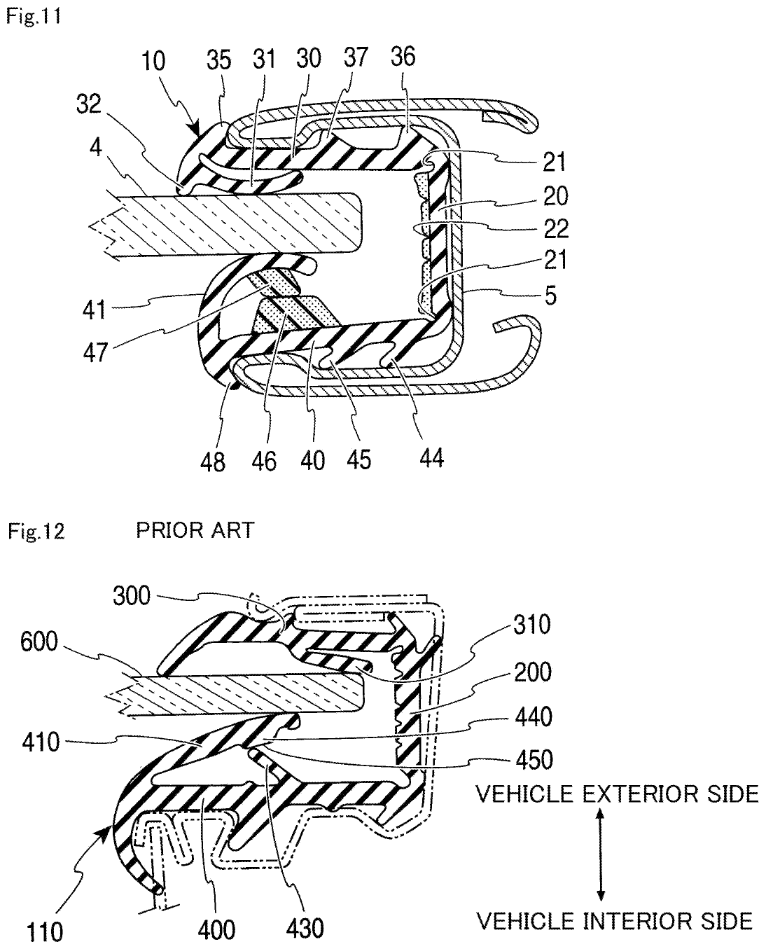

Next, a fifth embodiment will be described with reference to FIG. 11. The fifth embodiment is different from the second embodiment in that the sub lip 43 is not present. In order to prevent sound generated outside the vehicle compartment, such as wind noise, from passing through the vehicle body and reaching the inside of the vehicle compartment, and to improve sound insulation, measures to increase the plate thickness of the door glass 4 may be taken. The fifth embodiment is suitable for a case where the plate thickness of the door glass 4 is large.

FIG. 11 illustrates an abutment state between the seal lip protruding portion 47 of the vehicle interior seal lip 41 and the side wall protruding portion 46 when the door glass 4 is slightly lowered and displaced to the vehicle interior side. As is clear from FIG. 11, when the door glass 4 is slightly lowered and displaced to the vehicle interior side, the seal lip protruding portion 47 of the vehicle interior seal lip 41 is strongly pushed by the side wall protruding portion 46 and deformed.

As a result, a reaction force is generated in the vehicle interior seal lip 41 via the seal lip protruding portion 47, and the reaction force presses the vehicle interior surface of the door glass 4 to the vehicle exterior side via the vehicle interior seal lip 41. Therefore, it is possible to prevent the vehicle interior seal lip from being separated from the door glass and to prevent generation of an abnormal noise.

In FIG. 11, the side wall protruding portion 46 has a substantially trapezoidal shape, which has the short side on the vehicle exterior side and protrudes to the vehicle exterior side, but is not limited to the substantially trapezoidal shape, and may have an arc shape such as a rectangle or a semicircle, for example.

In addition, the protruding surface protruding portion 47b may not be formed on the seal lip protruding portion 47, and may have a shape as in the third embodiment or the fourth embodiment, for example. That is, the seal lip protruding portion 47 of the vehicle interior seal lip 41 may be configured to be strongly pushed and deformed by the side wall protruding portion 46.

Note that, when the door glass 4 is further displaced to the vehicle interior side as compared with FIG. 11, the vehicle interior seal lip 41 is further bent and deformed to the vehicle interior side, and the seal lip protruding portion 47 is strongly pushed and deformed by the side wall protruding portion 46, so that the reaction force to the vehicle interior seal lip 41 further increases.

In the embodiments of the present invention, a material constituting the glass run 10 can be formed of rubber, a thermoplastic elastomer, a soft synthetic resin, or the like. In the case of rubber, EPDM (ethylene propylene diene rubber) is desirable, and as the thermoplastic elastomer, olefinic thermoplastic elastomer (TP0) or dynamically crosslinked thermoplastic elastomer (TPV) is desirable from the viewpoint of weather resistance, recycling, cost, and the like.

The embodiments of the present invention are not limited to the above embodiments, and various modifications can be made without departing from the object of the present invention.

For example, in the first embodiment, the shapes in the second to fourth embodiments may be used for the seal lip protruding portion 47.

For example, the seal lip protruding portion 47 is formed at the position slightly on the root portion 41b of the vehicle interior seal lip 41 from the seal lip distal end portion 41a of the vehicle interior seal lip 41 in the first, second, and fifth embodiments, and is formed at the seal lip distal end portion 41a of the vehicle interior seal lip 41 in the third and fourth embodiments. However, the seal lip protruding portion 47 may be formed at the seal lip distal end portion 41a of the vehicle interior seal lip 41 in the first, second, and fifth embodiments, and may be formed slightly on the root portion 41b side of the vehicle interior seal lip 41 from the seal lip distal end portion 41a of the vehicle interior seal lip 41 in the third and fourth embodiments.

For example, in each of the above embodiments, the rear vertical side portion has been described, but the structure of the vehicle interior side portion is also applicable to a die-molded portion related to the front vertical side portion.

For example, in the above embodiments, it is assumed that the seal lip protruding portion 47 and the side wall protruding portion 46 are formed in the die-molded portion while extending the cross section of the extrusion-molded portion, but the above embodiments may be formed in the die-molded portion regardless of the cross section of the extrusion-molded portion regarding the shape of the vehicle interior side of the glass run.

What is claimed is:

1. A glass run attached to a door frame groove portion formed in a door frame, the glass run comprising a bottom wall, a vehicle exterior side wall, and a vehicle interior side wall as a basic skeleton, a vehicle exterior seal lip formed at or in a vicinity of a distal end of the vehicle exterior side wall, and a vehicle interior seal lip formed at or in a vicinity of a distal end of the vehicle interior side wall,
wherein, in a die-molded portion at the time of die molding for connecting extrusion-molded members or a region continuous with the die-molded portion at the time of die molding and the extrusion-molded members connected to the die-molded portion,
regarding at least a vertical side portion corresponding to one of vertical edge portions in front and rear of a vehicle of the door glass,
a seal lip protruding portion protruding to the vehicle interior side wall side is formed at or in a vicinity of a seal lip distal end portion of a general surface on the vehicle interior side wall side of the vehicle interior seal lip,
a sub lip is formed on a vehicle exterior surface of the vehicle interior side wall between the vehicle interior seal lip and the bottom wall, the sub lip protruding obliquely in a vehicle interior surface direction of the vehicle interior seal lip, and
the seal lip protruding portion and the sub lip abut on each other at the time of sliding contact with the door glass.

2. The glass run according to claim 1,
wherein a side wall protruding portion protruding to a vehicle exterior side is formed on the vehicle exterior surface of the vehicle interior side wall between the vehicle interior seal lip and the bottom wall, and
wherein the sub lip is formed to obliquely protrude from the side wall protruding portion in the vehicle interior surface direction of the vehicle interior seal lip.

3. The glass run according to claim 1,
wherein a protruding surface is formed on the seal lip protruding portion, and a protruding surface protruding portion protruding to the vehicle interior side wall side is formed on the seal lip distal end portion side of the vehicle interior seal lip of the protruding surface, and
wherein, when the door glass is displaced to a vehicle interior side,
the vehicle interior seal lip and the sub lip are configured to be changeable between a first support state in which a sub lip distal end portion of the sub lip and the protruding surface of the vehicle interior seal lip protruding portion excluding the protruding surface protruding portion abut on each other, and a second support state in which a vehicle exterior surface of the sub lip and the protruding surface protruding portion abut on each other.

4. The glass run according to claim 1,
wherein a protruding surface having a coupling surface with the general surface of the vehicle interior seal lip is formed on the seal lip protruding portion, and
wherein, when the door glass is displaced to a vehicle interior side,
the vehicle interior seal lip and the sub lip are configured to be changeable between a first support state in which a sub lip distal end portion of the sub lip or a vehicle exterior surface of the sub lip and a corner portion of the coupling surface and the protruding surface abut on each other, and a second support state in which the vehicle exterior surface of the sub lip and the protruding surface abut on each other.

5. The glass run according to claim 1,
wherein, when the door glass is displaced to a vehicle interior side,
the vehicle interior seal lip and the sub lip are configured to be changeable between a first support state in which a sub lip distal end portion of the sub lip and a general surface of the vehicle interior seal lip abut on each other, and a second support state in which the sub lip distal end portion and the general surface of the vehicle interior seal lip abut on each other and a vehicle exterior surface of the sub lip and the seal lip protruding portion abut on each other.

6. A glass run attached to a door frame groove portion formed in a door frame, the glass run comprising a bottom wall, a vehicle exterior side wall, and a vehicle interior side wall as a basic skeleton, a vehicle exterior seal lip formed at or in a vicinity of a distal end of the vehicle exterior side wall, and a vehicle interior seal lip formed at or in a vicinity of a distal end of the vehicle interior side wall,
wherein, in a die-molded portion at the time of die molding for connecting extrusion-molded members or a region continuous with the die-molded portion at the time of die molding and the extrusion-molded members connected to the die-molded portion,
regarding at least a vertical side portion corresponding to one of vertical edge portions in front and rear of a vehicle of the door glass,
a seal lip protruding portion protruding to the vehicle interior side wall side is formed at or in a vicinity of a seal lip distal end portion of a general surface on the vehicle interior side wall side of the vehicle interior seal lip,
a side wall protruding portion protruding to a vehicle exterior side is formed on a vehicle exterior surface of the vehicle interior side wall between the vehicle interior seal lip and the bottom wall, and
the seal lip protruding portion and the side wall protruding portion abut on each other at the time of sliding contact with the door glass.
